(19) United States
(12) Patent Application Publication
(10) Pub. No.: US 2026/0128273 A1
(43) Pub. Date: May 7, 2026

(54) LAMINATING APPARATUS FOR LAMINATING MULTILAYER ENDLESS WEBS FOR PRODUCING ENERGY CELLS

(71) Applicant: KÖRBER TECHNOLOGIES GMBH, HAMBURG (DE)

(72) Inventors: Michael KLEINE WÄCHTER, Lankau (DE); Manfred FOLGER, Hamburg (DE); Dennis SPRINGBORN, Hamburg (DE)

(21) Appl. No.: 19/119,622

(22) PCT Filed: Oct. 17, 2023
(86) PCT No.: PCT/EP2023/078817

§ 371 Date: Apr. 9, 2025

(30) Foreign Application Priority Data
Oct. 25, 2022 (DE) 10 2022 128 219.8

(51) Int. Cl. H01M 4/04; B32B 37/00; B32B 37/10; B32B 37/20

(52) U.S. Cl. CPC H01M 4/0435; B32B 37/0053; B32B 37/1027; B32B 37/20; B32B 2457/10

(57) ABSTRACT

The invention relates to a laminating apparatus for a multilayer endless web, which is made of at least one separator web and at least one electrode, for producing energy cells, comprising a pressing device which laminates the multilayer endless web while exerting a compressive force. The pressing device has a pressing surface with at least one recess which is arranged such that when the compressive force is being exerted via the pressing surface, the recess overlaps with at least one of the edges of the electrodes.

The present invention relates to a laminating apparatus for laminating multilayer endless webs for producing energy cells having the features of the preamble of claim 1.

Energy cells or energy storage devices within the meaning of the invention are used, for example, in motor vehicles, other land vehicles, ships, aircraft or also in stationary systems, such as photovoltaic systems, in the form of battery cells or fuel cells in which very large amounts of energy have to be stored over longer periods of time.

For this purpose, such energy cells may have a structure consisting of a plurality of segments stacked to form a stack. These segments are each formed from alternating anode sheets and cathode sheets, which are separated from one another by separator sheets that are also produced as segments. The segments are pre-cut in the production process and then placed on top of each other in the predetermined sequence to form the stacks and joined together by lamination. The anode sheets and cathode sheets are first cut from an endless web and then placed individually at intervals on an endless web of separator material. This subsequently formed “two-ply” endless web made of the separator material with the anode sheets or cathode sheets placed on top is then cut into segments again in a second step by means of a cutting apparatus, wherein the segments in this case are formed in a double layer by a separator sheet with an anode sheet or cathode sheet arranged on top. If this is technically feasible or necessary from a manufacturing perspective, the endless webs of separator material with the anode sheets and cathode sheets placed on top of each other can also be placed on top of each other before cutting, so that an endless web is formed with a first endless layer of separator material with anode sheets or cathode sheets placed thereon and a second endless layer of separator material with anode sheets or cathode sheets placed in turn thereon. This “four-ply” endless web is then cut into segments by means of a cutting apparatus, which segments are in this case formed in four layers with a first separator sheet, an anode sheet, a second separator sheet and a cathode sheet lying thereon. The advantage of this solution is that one cut can be saved. Furthermore, the cut electrodes can also be placed on an endless separator web and stacked on top of each other by another endless separator web to form a three-ply endless web, from which three-ply segments with a separator sheet, an electrode sheet and another separator sheet are then cut. “Segments” within the meaning of this invention are therefore single-ply segments of a separator material, anode material or cathode material, or also two-ply, three-ply or four-ply segments of the structure described above.

Furthermore, the “two-ply” or “four-ply” endless webs described above can also be supplemented by placing another separator web on the electrodes to form a “three-ply” or “five-ply” endless web, which then has a separator web on both sides.

Alternatively, the electrodes can also be provided as endless webs, i.e. uncut in the “two-ply”, “three-ply”, “four-ply” or “five-ply” endless webs, which are then cut to considerably longer lengths and then wound up, for example. Alternatively, the endless webs can be wound first and then cut after winding is complete. In this case, the electrodes in the endless webs are not present as spaced segments, but instead in a single segment that extends without interruption in the intermediate space between the separator webs.

Furthermore, an electrode in the form of a copper web or copper foil or a comparable carrier material with an intermittent coating can also be provided in the endless web, in which the coatings each form sectional, spaced apart elevations in the electrode.

To laminate the “two-ply”, “three-ply”, “four-ply” or “five-ply” endless webs, they are passed between two pressing devices which exert a compressive force on the endless webs. The electrodes are compressed with the separator webs in these endless webs. In principle, the electrodes are connected and laminated to the separator webs using a pressing device by exerting the compressive force. In addition, lamination can be assisted by the generation of heat as a result of the compressive force. Furthermore, additional heating or cooling zones can be provided which regulate the temperature of the endless webs during lamination. In order to achieve a high-quality connection, it is desirable that the endless webs are exposed to as equal a compressive force as possible over their longitudinal and transverse extension.

One problem here is that the electrode(s) are narrower than the endless web(s) of the separator material, so that the separator material projects laterally beyond the electrode(s). This means that the electrodes have free edges on their edge sides, while the separator material overlaps the electrodes laterally.

If the electrodes in the endless webs are already arranged at intervals from each other in the form of cut segments, the electrodes form additional intermediate spaces in the endless webs due to their spacing, whereby the electrodes additionally keep the separator webs at an interval from each another in the intermediate spaces due to their thickness. This means that the electrodes have additional free edges on the edges bordering the intermediate spaces.

Since the pressing force can only be increased to a limited extent so that the functionality of the electrodes is not impaired by excessive compression, and damage to the energy cells in the region of the edges of the electrodes is always detrimental to the quality of the energy cells and is therefore to be avoided as far as possible, the lamination of the endless webs in the edge portions and, if present, in the regions of the intermediate spaces between the electrodes is problematic due to the free edges of the electrodes present there.

Against this background, the invention is based on the object of creating a laminating apparatus which allows lamination of the endless webs with a reduced probability of damage to the electrodes in the region of the edges.

According to the invention, a laminating apparatus having the features of claim 1 is proposed to achieve the object. Further preferred embodiments of the invention can be found in the dependent claims, the figures, and the associated description.

According to the basic idea of the invention, it is proposed that the pressing device has a pressing surface with at least one recess, which is arranged such that when the compressive force is exerted via the pressing surface, it overlaps with at least one of the edges of the electrodes.

The recess provided on the pressing surface in the proposed arrangement creates a contour of the pressing surface which allows the electrodes to be relieved in the region of the edges. The pressing surface therefore has a contour which is shaped by the recess in a targeted manner in such a way that the endless web is not exposed to any compressive force in the region of the edges during lamination. Conversely, this means that the compressive force for laminating the endless webs can be increased without increasing the compressive force in the region of the edges of the electrodes and thus increasing the probability of damage to the electrodes in the region of their edges. Due to the facilitated increase in the compressive force, the separator webs can also be better connected to each other in the region between the electrodes, so that the electrodes are then better fixed to each other in the finished laminated endless web and cannot slip. The same applies to the electrodes in the segments cut from the endless web, in particular during the subsequent operation of the energy cell. The proposed solution is particularly advantageous when the electrode is narrower than the separator web and the separator web projects laterally beyond the electrode.

It is further proposed that the pressing device laminates the multilayer endless web in the laminating apparatus by the application of heat. The lamination, i.e. the connection of the endless webs of separator material to each other and to the electrodes, is achieved by polymers penetrating from one layer into the other, which in turn is caused by the adhesion forces acting at the interfaces. It is precisely these adhesion forces that can be achieved more easily by the application of heat. However, care must be taken to ensure that the material in the interfaces is not compressed to such an extent by the application of heat and the acting compressive force that the ion exchange, which is important for the function of the energy cell, is prevented.

It is further proposed that at least one first and one second recess are provided on the pressing surface, which extend in the longitudinal direction of the endless web and are arranged at a distance from each other which is smaller than the distance between the edge sides of the electrode extending in the longitudinal direction of the endless web. The first and second recesses also relieve the load on the electrode during lamination in the region of its front and rear edges in the feed direction. The distance between the first recess and the second recess is the distance between the facing edge sides of the recesses.

It is further proposed that a plurality of electrodes arranged regularly at intervals from each other are provided in the endless web, and that at least one third recess and one fourth recess are provided, and the fourth recess is at a smaller distance from the third recess than the length of the electrodes in the longitudinal direction of the endless web. The third and fourth recesses have the same function as the first and second recesses and are arranged to cover the front and rear edges of the electrode with respect to the longitudinal direction of the endless web during lamination. The distance between the third recess and the fourth recess is deliberately chosen to be smaller than the length of the electrodes, so that the third recess and the fourth recess always overlap with the edges when the movement of the pressing surface is synchronized accordingly with the endless web. The distance between the third and fourth recesses is the distance between the facing edge sides of the two recesses. If the endless web has an intermittent coating, the coated portions correspond to the electrodes and the distances between the coatings correspond to the intervals between the electrodes.

The first recess, the second recess, the third recess and the fourth recess can be shaped and arranged such that they complement each other to form a closed, ring-shaped recess, the shape of which corresponds to the shape of the outer edge of the electrodes. The ring shape of the recess can be rectangular, oval, or any other shape depending on the shape of the electrodes. Since the recess has a closed ring shape, the entire edge of the electrode on one surface is covered by the recess and thus relieved during lamination.

It is further proposed that the pressing device comprises two press rollers with a circular cross section, which are arranged such that between their lateral surfaces a gap is provided through which the endless web runs. The advantage of the proposed solution is that by using press rollers in the proposed arrangement, the lamination can be preferably carried out in a drum run with a very high production capacity, i.e., transport speed of the endless web.

It is further proposed that the gap has a gap width which is smaller than the thickness of the endless web. The proposed gap dimensioning allows the compressive force required for lamination to be applied by the press rollers by transporting the endless web through the gap. A special feed movement of the press rollers is therefore no longer necessary.

The first and/or the second recess and/or the third recess and/or the fourth recess can preferably be arranged in a portion of the lateral surface(s) of one or both press rollers. By forming the recess(es) in the lateral surface(s) of the press roller(s), this directly forms the pressing surface adapted to the contour of the electrodes arranged in the endless web.

It is further proposed that the first recess and the second recess are arranged on the edge sides of the lateral surface. As a result, they come into contact with the edge portions of the endless web as the press rollers roll along. The first recess and the second recess can be realized in the form of circumferential closed rings on the lateral surface, so that the first and second recesses lie continuously on the endless web and are relieved in the region of the lateral edges of the electrodes.

It is further proposed that the third recess and the fourth recess are arranged parallel to the axes of rotation of the press roller and each deepen a portion of the lateral surface, which, in the spread of the arc length of the lateral surface, have a distance from each other which is smaller than the length of the electrodes in the longitudinal direction of the endless web. Owing to the proposed solution, the press roller with its third and fourth recesses always overlaps exactly with the front and rear edges of the electrodes in the feed direction of the endless web, provided that the rotational movements of the press rollers and the transport movement of the endless web are properly synchronized. The distance between the third and fourth recesses is the spread length of the lateral surface between the facing edge sides of the recesses.

The press rollers are preferably arranged such that their axes of rotation are aligned parallel to each other. Owing to the proposed arrangement of the press rollers, they can be coupled and/or synchronized particularly easily using a simple gear system. Furthermore, this makes it possible to achieve a particularly compact design of the laminating apparatus.

It is further proposed that the pressing device has at least one pressing belt which is arranged such that it comes into contact with one of the surfaces of the endless web. The pressing belt can be used to equalize the pressing force acting on the endless web. The pressing belt can preferably have an identical or larger width transverse to the feed direction of the endless web so that the endless web is subjected to the pressing force over its entire width and is thus laminated. The pressing belt can be designed in such a way that it generates the compressive force itself or is subjected to a compressive force via a separate pressure-generating device, such as a press roller. In the latter case, the compressive force is transferred from the pressing belt to the endless web. The pressing belt itself can be designed in the form of a flexible fiber-reinforced textile belt, a steel belt or a very fine link chain or the like. The pressing belt can be designed as a driven continuous belt or as a stationary pressing belt with a friction-reduced surface. If the pressing belt is designed as a driven continuous belt, it can also be used to transport the endless web. However, if the pressing belt is formed by a stationary pressing belt, an additional device is required to transport the endless web. In this case, the endless web is actively pulled past the pressing belt.

In this case, the first recess and/or the second recess and/or the third recess and/or the fourth recess can also be arranged in the surface of the pressing belt, which is advantageous because the pressing belt rests on the surface of the endless web and thus directly exerts or transmits the pressing force. This means that the contour of the pressing belt itself, due to the arrangement of the recess therein, is adapted to the shape and geometry of the endless web and the electrode(s) arranged thereon.

It is further proposed that two pressing belts are provided which are arranged such that, between their opposite surfaces facing the endless web, a gap is provided through which the endless web runs. The endless web can thus be subjected to a compressive force and pressed from both sides.

The gap width is preferably slightly smaller than the thickness of the endless web, so that the endless web is automatically subjected to the pressing force for lamination when it passes through and is supported accordingly by the pressing belts.

It is further proposed that the pressing device has two oppositely arranged pressing surfaces with which it comes into contact with different sides of the endless web, and that first recesses and/or second recesses and/or third recesses and/or fourth recesses are provided on the pressing surfaces, and that the first recesses, second recesses, third recesses and/or fourth recesses of the pressing surfaces have different distances from each other and/or different depths and/or shapes.

Due to the different distances between the recesses, the pressing surfaces in the mold can be individually designed in relation to the contour of the two sides of the endless web. If the endless web is formed, for example, as a four-ply endless web or a five-ply endless web with cathodes and anodes arranged therein according to the structure described above, this can take into account the fact that the anodes are generally larger than the cathodes and thus the edges to be protected of the anodes have larger distances than the edges of the cathodes. Furthermore, the recesses can have different depths, so that the compressive forces exerted can be adapted differently in terms of their distribution and size to the surfaces of the endless webs. Furthermore, the different shapes of the recesses allow different courses of the edges of the electrodes to be taken into account.

It is also proposed that the pressing surface be adjustable in its width. Due to the adjustability of the width of the pressing surface, the laminating apparatus can be set to laminate endless webs of different widths. The width of the pressing surface is the perpendicular direction to the longitudinal direction of the endless web in the plane of the endless web.

Furthermore, the pressing surface can preferably have a width which corresponds to the width of the endless web or a multiple thereof. The proposed solution means that the laminating apparatus is specifically designed to laminate an endless web of a specific width, or a plurality of endless webs of a specific width can also be laminated in a parallel arrangement. If the pressing surface is adjustable, predetermined positions of the widths of the pressing surface can also be provided for this purpose, so that the pressing surface can be adjusted with little effort from a position for laminating a single endless web to a position for two or more endless webs arranged in parallel.

The invention is explained below using preferred embodiments with reference to the accompanying figures, in which:

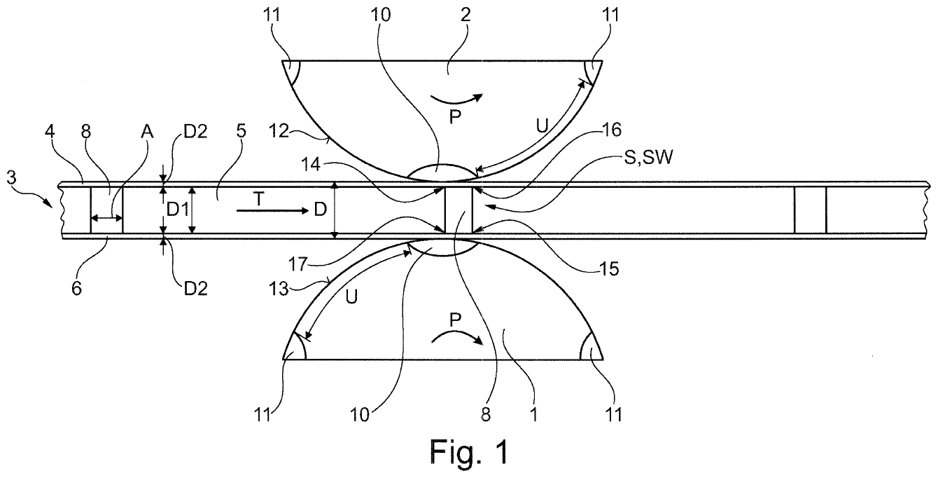

FIG. 1 shows a section of a laminating apparatus with a three-ply endless web and a pressing device with two press rollers; and

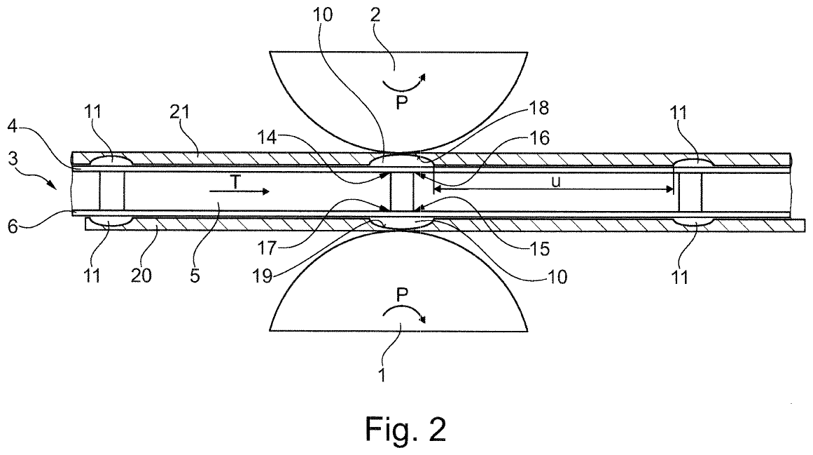

FIG. 2 shows a section of a laminating apparatus with a three-ply endless web and a pressing device with two press rollers and two pressing belts.

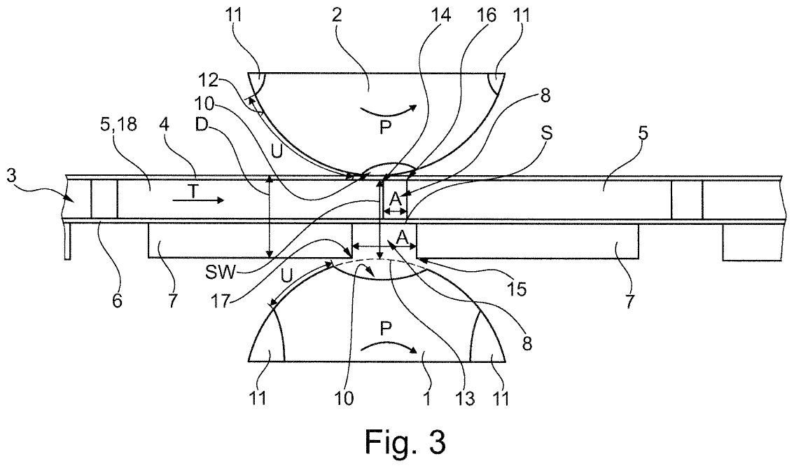

FIG. 3 shows a section of a laminating apparatus with a four-ply endless web and a pressing device with two press rollers.

FIG. 1 shows a detail of a laminating apparatus according to the invention. The laminating apparatus comprises a pressing device with two press rollers 1 and 2, which are designed as cylindrical drums with a circular cross section. The press rollers 1 and 2 are aligned with their axes of rotation parallel to each other and arranged such that there is a gap S between their lateral surfaces 12 and 13 with a gap width SW that is constant in the direction of the axes of rotation, i.e., perpendicular to the plane of representation.

Furthermore, an endless web 3 to be laminated is provided, which runs through the gap S and has a thickness D. The endless web 3 is formed by a “three-ply” endless web 3 with a separator web 4 on the upper side and a separator web 6 on the lower side and electrodes 5 arranged in between. The electrodes 5 are arranged with intermediate spaces 8 at identical distances A from each other and have a smaller width than the separator webs 4 and 6, so that the separator webs 4 and 6 project laterally beyond the electrodes 5.

The gap width SW of the gap S is smaller than the thickness D of the endless web 3, so that the endless web 3 is slightly compressed and laminated when passing through the gap S. The thickness D 2 of the separator webs 4 and 6 is 15 to 25 μm, while the electrodes 5 have a thickness D 1 of 150 to 400 μm. This results in a thickness D of the electrode web 3 of approximately 180 μm to 450 μm in the present exemplary embodiment. The gap width SW is smaller by 20 to 100 μm, preferably 40 to 60 μm, than the thickness D of the endless web, so that the endless web 3 is slightly compressed when passing through the gap S. The intermediate spaces 8 are formed by the spacing of the electrodes 5 and have a height which corresponds to the thickness D 1 of the electrodes 5, i.e. 180 to 400 μm. Furthermore, the intermediate spaces 8 have a length in the feed direction corresponding to the interval A of the electrodes 5 of 3 mm between the anodes and 6 mm between the cathodes, wherein it is desirable to make the intervals A between the electrodes 5 as small as possible in order to increase the material utilization rate of the endless web 3 and the number of electrodes 5 in a predetermined length of the endless web 3.

The endless web 3 is transported in the feed direction T and pulled through the gap S. The press rollers 1 and 2 can themselves be actively driven, for example by individual drives in the form of servo motors, to rotate in opposite directions in the direction of the arrows P, so that they also actively transport the endless web 3 through the frictional connection. Alternatively, the press rollers 1 and 2 can also be mounted so that they can only rotate, so that they themselves are driven by the endless web 3 due to the frictional connection to the rotary movements. In this case, the press rollers 1 and 2 roll only passively on the surfaces of the endless web 3.

Provided on the two press rollers 1 and 2 are third recesses 10 and fourth recesses 11 in the form of radially inwardly directed depressions in the lateral surfaces 12 and 13, which are arranged such that they overlap with at least one of the edges 14, 15, 16 or 17 of the electrodes 5 during the rotational movement of the press rollers 1 and 2. Furthermore, the third recesses 10 and the fourth recesses 11 in the spread of the peripheral portion relative to the axes of rotation of the press rollers 1 and 2 are longer than the distances A of the electrodes 5, so that they each cover two edges 14 and 16 and 15 and 17 of two opposite electrodes 5 on one side. The third recesses 10 and the fourth recesses 11 are arranged on the press rollers 1 and 2 in such a way that they are positioned in the region of the edges 14, 15, 16 and 17 during the transport movement of the endless web 3 and the rotational movements of the press rollers 1 and 2 on the endless web 3 and thus relieve the electrodes 5 in the region of the edges 14, 15, 16 and 17.

Furthermore, in addition to the third recesses 10 and the fourth recesses 11 on the press rollers 1 and 2, further recesses (not shown) can be provided, which are arranged on the lateral surfaces 12 and 13 in such a way that the length of the spread of the arc segments in the direction of rotation of the press rollers between the third recesses 10 and the fourth recesses 11 and the further recesses each corresponds at most to the length of the electrodes 5. Thus, the third recesses 10, the fourth recesses 11 and the further recesses always cover the edges 14, 15, 16 and 17 of the electrodes 5 at an intermediate space 8. Insofar as the invention is described with reference to the third and fourth recesses 10 and 11 and subsequently with reference to the first and second recesses, the designation first, second, third and fourth does not imply any order or hierarchy. Thus, the terms “third” and “fourth” do not necessarily presuppose the existence of a first and second recess, and vice versa. The designations serve only to distinguish the recesses, wherein the recesses are each defined by their orientation and arrangement in relation to each other.

The lateral surfaces 12 and 13 here form the pressing surfaces of the pressing device, which are individually contoured for the endless web 3 to be laminated by the formation of the third recesses 10 and the fourth recesses 11 and, if present, by the further recesses. The first recesses 10 and the fourth recesses 11 and the intermediate spaces 8 are shown in an exaggerated manner for the sake of clarity.

FIG. 2 shows an alternative embodiment of the invention. In addition to the two press rollers 1 and 2, the pressing device here also comprises two pressing belts 20 and 21, which rest on the upper side and the lower side of the endless web 3. The press rollers 1 and 2 are designed and arranged identically to the press rollers 1 and 2 of FIG. 1 and differ only in that they are designed as cylindrical drums with a lateral surface 12 and 13 with an identical radius, i.e. without recesses, over the circumference. The press rollers 1 and 2 rest on the free surfaces of the two pressing belts 20 and 21. The pressing belts 20 and 21 are provided with the third recesses 10 and fourth recesses 11 on their surfaces facing the endless web 3 and thus form the pressing surface of the pressing device acting on the endless web 3. However, the press rollers 1 and 2 can also have different diameters and radii, provided that this is advantageous for lamination.

The third recesses 10 and the fourth recesses 11 of the pressing belts 20 and 21 are dimensioned and arranged corresponding to the third recesses 10 and the fourth recesses 11 on the press rollers 1 and 2 of the first exemplary embodiment. The relevant gap S and the gap width SW for laminating the endless web 3 is in this case defined by the distance between the pressing belts 20 and 21, so that the press rollers 1 and 2 with their lateral surfaces 12 and 13 have a distance increased by the sum of the thicknesses of the pressing belts 20 and 21. The third and fourth recesses 10 and 11 have a distance U between the edge sides facing each other which is smaller than the length of the electrodes 5 in the transport direction T. Furthermore, further recesses can be arranged on the pressing belts 20 and 21, which likewise have a distance from each other that is smaller than the length of the electrodes 5 in the feed direction T of the endless web 3. The distance between the recesses is the distance between the facing edge sides of the recesses.

Alternatively or additionally, in addition to the third and fourth recesses 10 and 11 on the edge sides of the pressing belts 20 and 21 or the press rollers 1 and 2 in the exemplary embodiment of FIG. 1, further first and second recesses can be provided which are arranged in such a way that they cover the lateral edges of the electrodes 5 facing in the feed direction T of the endless web 3. This means that the lateral edges of the electrodes 5 in the endless web 2 are also relieved during lamination.

If both third and fourth recesses 10 and 11 and first and second recesses are provided, the third recesses 10 and fourth recesses 11 and the first and second recesses can complement each other to form a recess having a closed ring shape, wherein the ring shape corresponds to the edge profile of the electrodes 5. If the electrodes 5 are rectangular, for example, the recess is preferably designed in the form of a closed rectangular ring and completely covers the edge of the electrode 5 on one side.

The third and fourth recesses 10 and 11 can be provided on the press rollers 1 and 2 or on the pressing belts 20 and 21 in a repeating regular arrangement which, when spread, corresponds to the pattern of the edges of the electrodes 5 in the endless web 3.

FIG. 3 shows an exemplary embodiment of the invention, in which the endless web 3 is formed by a “four-ply” endless web 3 with a separator web 4 on the upper side and a separator web 6 in the middle, a plurality of anodes 18 arranged between the separator webs 4 and 6, and a plurality of cathodes 7 arranged under the central separator web 6. The anodes 18 are larger than the cathodes 7, so that the anodes 18, when arranged in pairs with the cathodes 7, have a smaller frontal interval A from each other than the cathodes 7. Thus, the third and fourth recesses 10 and 11 in the lower press roller 1, which comes into contact with the cathode side of the endless web 3, have a greater length when spread in the circumferential direction of the press roller 1 than the third and fourth recesses 10 and 11 in the upper press roller 2, which comes into contact with the anode side of the endless web 3. The third and fourth recesses 10 and 11 on the upper press roller 2 have, when the recessed lateral surface 12 is spread in the direction of rotation P of the press roller 2, a length which is dimensioned in such a way that, when in contact with the upper separator web 4, they cover the intermediate space 8 between the anodes 18 and the edges 14 and 16 of the two adjacent anodes 18. The third and fourth recesses 10 and 11 on the lower press roller 1 have, when the recessed lateral surface 13 is spread in the direction of rotation P of the press roller 1, a length which is dimensioned in such a way that, when passing the endless web 3, they cover the intermediate space 8 between the cathodes 7 and the edges 15 and 17 of the two adjacent cathodes 7.

The press rollers 1 and 2 here form a pressure-generating device which exerts a compressive force on the pressing belts 20 and 21. However, a rod carpet, a stamping unit with corresponding pressure cylinders, pneumatic pressure-generating devices with, for example, inflatable cushions or the like can also be used as the pressure-generating device, provided that they are suitable for applying the necessary pressure evenly to the pressing belts 20 and 21.

In the exemplary embodiments, the lamination of an endless web 3 with cut electrodes 5 arranged at distances A from each other has been described. However, it is also conceivable to laminate an endless web 3 with an endless electrode web using the laminating apparatus. In this case, the third and fourth recesses 10 and 11 are omitted and only the first and second recesses are provided in the region of the edge sides of the pressing surfaces. The first and second recesses are arranged according to the course of the two longitudinal edges of the electrode track and cover them during lamination with the desired relief effect.

The first and second recesses run in the longitudinal direction of the pressing surfaces and the endless web 3 to be laminated and the feed direction T and can therefore also be regarded as longitudinal grooves in the pressing surfaces which are arranged parallel to each other and have a distance from each other which is smaller than the width of the electrode web, wherein the distance between the first and second recesses is the distance between the edge sides of the recesses facing each other.

The third and fourth recesses 10 and 11 run transversely to the pressing surfaces and to the laminating endless web 3 and to the feed direction T, and can therefore also be regarded as transverse grooves, which each have a distance (U) from each other that is smaller than the length of the electrodes 5 in the longitudinal direction of the endless web 3. If the third and fourth recesses 10 and 11 are formed on the press rollers 1 and 2 according to FIGS. 1 and 3, the distance U corresponds to the length of the spread arc length of the lateral surfaces 12 and 13 between the mutually facing edge sides of the third and fourth recesses 10 and 11.

Due to the smaller dimensions of the cathodes and the resulting larger distances A between the electrodes 5 on the lower cathode side in the representation in FIG. 3 compared to the electrodes on the upper anode side in the representation in FIG. 3, the third and fourth recesses 10 and 11 of the press roller on the cathode side have smaller distances U from each other and are themselves larger in order to cover the larger intermediate spaces 8 than the third and fourth recesses 10 and 11 on the press roller 2, which comes into contact with the anode side of the endless web 3.

If the electrodes 5 are arranged uncut in the endless web 3, i.e. are arranged in a single piece, the intermediate spaces 8 and thus also the third and fourth recesses 10 and 11 are omitted, and only the first and second recesses are provided. Furthermore, the first and second recesses in the edge sides of the pressing surfaces can be individually or both omitted, provided that a corresponding relief of the edges is not required here, so that in this case only the third and/or the fourth recesses 10 and 11 can be provided. If an intermittent coated endless web is provided in the endless web 3, the intermediate spaces 8 are arranged between the coated portions, and the first, second, third and/or fourth recesses 10, 11 serve in this case to relieve the endless web 3 during lamination in the region of the lateral edges of the coated portions.

In general, the load on the endless web 3 during lamination in the region of the edges of the electrodes 5 is reduced by the fact that the pressing surfaces do not touch the electrodes 5 in the region of the edges due to the recesses.

Furthermore, the depths, shapes and arrangements of the recesses can be selected differently and designed individually to achieve an optimized compressive force distribution.

The designation of the recesses as first, second, third, and fourth recess serves only to distinguish the recesses. It is not necessary for the realization of the concept of the invention that, when the third and fourth recesses 10 and 11 are realized, the first and second recesses must necessarily also be realized. In this case, the first elevation according to claim 1 would be realized by the third or fourth elevation 10 or 11. The same applies to the opposite case where no third and fourth elevations 10 and 11 are provided, but instead only the first and second elevations are provided, on the edge sides of the pressing surfaces.

1. A laminating apparatus for a multilayer endless web made up of at least one separator web and at least one electrode for producing energy cells, having
a pressing device that laminates the multilayer endless web while exerting a compressive force,
wherein
the pressing device has a pressing surface with at least one recess, which is arranged such that when the compressive force is exerted via the pressing surface, it overlaps with at least one of the edges of the electrodes, wherein at least one first and one second recess are provided on the pressing surface, which extend in the longitudinal direction of the endless web and are arranged at a distance from each other that is smaller than the distance between the edge sides of the electrode extending in the longitudinal direction of the endless web.

2. The laminating apparatus according to claim 1, wherein
the pressing device laminates the multilayer endless web by applying heat.

3. (canceled)

4. The laminating apparatus according to claim 1, wherein
a plurality of electrodes arranged regularly at distances from each other are provided in the endless web, and
at least one third recess and one fourth recess are provided on the pressing surface, and
the fourth recess has a smaller distance from the third recess than the length of the electrodes in the longitudinal direction of the endless web.

5. The laminating apparatus according to claim 4, wherein
the first recess, the second recess, the third recess and the fourth recess can be shaped and arranged such that they complement each other to form a recess, the shape of which corresponds to the outer edge of the electrodes.

6. The laminating apparatus according to claim 1, wherein
the pressing device comprises two press rollers with a circular cross section, which are arranged such that between their lateral surfaces a gap is provided through which the endless web runs.

7. The laminating apparatus according to claim 6, wherein
the gap has a gap width which is smaller than the thickness of the endless web.

8. The laminating apparatus according to claim 4, wherein
the first recess and/or the second recess and/or the third recess and/or the fourth recess are arranged on a portion of the lateral surface(s) of one or both of the press rollers.

9. The laminating apparatus according to claim 7, wherein
the first recess and the second recess are arranged on the edge sides of the lateral surface.

10. The laminating apparatus according to claim 8, wherein
the third recess and the fourth recess are arranged parallel to the axes of rotation of the press rollers, and
the third recess and the fourth recess in the spread of the arc length of the lateral surface have a distance from each other which is smaller than the length of the electrodes in the longitudinal direction of the endless web.

11. The laminating apparatus according to claim 6, wherein
the press rollers are arranged such that their axes of rotation are aligned parallel to each other.

12. The laminating apparatus according to claim 1, wherein
the pressing device has at least one pressing belt which is arranged such that it comes into contact with one of the surfaces of the endless web.

13. The laminating apparatus according to claim 12, wherein
the recess(es) is or are arranged on the surface of the pressing belt

14. The laminating apparatus according to claim 12, wherein
two pressing belts are provided, which are arranged such that between their opposite surfaces facing the endless web a gap is provided through which the endless web runs.

15. The laminating apparatus according to claim 14, wherein
the gap width of the gap is slightly smaller than the thickness of the endless web.

16. The laminating apparatus according to claim 1, wherein
the pressing device has two oppositely arranged pressing surfaces with which it comes into contact with different sides of the endless web, and
first recesses and/or second recesses and/or third recesses and/or fourth recesses are provided on the pressing surfaces, and
the first recesses, second recesses, third recesses and/or fourth recesses of the pressing surfaces have different distances from each other and/or different depths and/or different shapes.

17. The laminating apparatus according to claim 1, wherein
the pressing surface is adjustable in width.

18. The laminating apparatus according to claim 1, wherein
the pressing surface has a width which corresponds to the width of the endless web or a multiple thereof.

19. The laminating apparatus according to claim 8, wherein
the press rollers are arranged such that their axes of rotation are aligned parallel to each other.
